(19) United States
(12) Patent Application Publication
(10) Pub. No.: US 2025/0145192 A1
(43) Pub. Date: May 8, 2025

(54) SYSTEM AND METHOD FOR OPTIMIZING UTILIZATION OF CHASSIS RESOURCES OF A HUB BASED ON A DUAL-STREAM RESOURCE OPTIMIZATION

(71) Applicant: BNSF Railway Company, Fort Worth, TX (US)

(72) Inventors: Dasaradh R. Mallampati, Trophy Club, TX (US); Vishal Badyal, Haslet, TX (US); Paul Kuhn, Fort Worth, TX (US); April Y. Kuo, Colleyville, TX (US)

(73) Assignee: BNSF Railway Company, Fort Worth, TX (US)

(21) Appl. No.: 18/911,420

(22) Filed: Oct. 10, 2024

Related U.S. Application Data
(63) Continuation-in-part of application No. 18/501,608, filed on Nov. 3, 2023, now Pat. No. 12,217,199.

(51) Int. Cl. B61L 27/16; B61L 27/04

(52) U.S. Cl. CPC B61L 27/16; B61L 27/04

(57) ABSTRACT

Systems and techniques for optimizing utilization of chassis of a hub based on a dual-stream resource optimization (DSRO). In embodiments, a chassis optimization system optimizes utilization of chassis resources in a hub based on a unit traffic prediction in an optimized operating schedule, where the unit traffic prediction includes a prediction of containers and chassis to arrive at the hub at each time increment of a planning horizon. The chassis optimization system optimizes the utilization of chassis resources by managing capacity constraints associated with the chassis resource capacity in the hub over the planning horizon to optimize the use of the chassis resource capacity to maximize unit throughput through the hub based on the unit traffic prediction and the chassis resources capacity, and by managing the chassis resource capacity surplus/deficit cycles over the planning horizon to maximize the unit throughput over the planning horizon based on the unit traffic prediction.

### CROSS-REFERENCE TO RELATED APPLICATIONS

The present application is a continuation-in-part of pending and co-owned U.S. patent application Ser. No. 18/501,608, entitled “SYSTEMS AND METHODS FOR INTERMODAL DUAL-STREAM-BASED RESOURCE OPTIMIZATION”, filed Nov. 3, 2023, the entirety of which is herein incorporated by reference for all purposes.

### TECHNICAL FIELD

The present disclosure relates generally to resource optimization systems, and more particularly to systems and devices for optimizing utilization of chassis resources of a hub based on a dual-stream resource optimization.

### BACKGROUND

Transportation hubs enable the coordination of operations required for goods to be received, securely stored, systematically sorted, and expediently loaded for delivery. In particular, intermodal hub facilities (IHFs) function as critical junctures where units, typically containers bearing goods, are transitioned between different transportation modes including, but not limited to, rail, road, maritime, and aerial transport. These hubs are characterized by their capabilities to handle and process units that are designed for multi-modal transport, and in this manner serving as integral nodes in transportation networks.

The operational context of an IHF can be described as two distinct operational flows. In one operational flow of an IHF, units are dropped off at or in-gated (IG) into the IHF by customers to be processed and then loaded onto trains for delivery to respective destinations. Upon arrival at the respective destinations, units are promptly unloaded and prepared for the final leg of their journey to the customer. In another operational flow of the IHF, inbound (IB) units (e.g., units arriving at the IHF via trains carrying the units) are unloaded form the inbound trains and processed for subsequent customer pickup at the IHF. This high-volume processing of units, and the specific nature of the IB and IG operational flows underscores the critical role of IHF resources in handling the influx of IG units received from customers and IB units arriving via trains.

Despite the critical nature of these operations, there are many inefficiencies in current IHF processes, rooted primarily in the management of IHF resources during IHF operations, such as chassis resources. Chassis typically include structures or frames (e.g., trailers, semitrailers, trucks, etc.) that are designed or configured to securely carry or transport a container (e.g., a unit) thereon. Typically, during operations of an IHF, customers may transport the units in chassis when bringing them into the IHF. Once in the IHF, the units, along with the chassis in which the units are brough in, may be placed on storage (e.g., a parking lot space) while waiting for the unit to be assigned to an outbound train. Once the unit is assigned to an outbound train, the unit may be removed from the chassis and loaded onto the assigned outbound train, and the chassis is, at this point, free to be used again. On the other side of operations (e.g., the IB flow), an inbound train carrying units may arrive at the IHF. In order to unload the inbound train, chassis may be allocated to each unit to be unloaded. The units may be removed from the inbound train and placed on corresponding chassis. The units, along with their chassis, may be placed on storage to wait to be picked up by customers who may remove the units along with their chassis from the IHF.

In these cases, while an IG unit is waiting to be assigned and loaded to an outbound train, the chassis in which the IG unit was brought in may be occupied by the unit until the unit is actually loaded onto the assigned train. As such, the occupied chassis cannot be used to hold another unit, such as a unit being unloaded from an inbound train. On the other hand, an IB unit may not be unloaded from the inbound train until a chassis is available. However, due to the complex, and often unbalanced, unit traffic flow between the IG flow and the IB flow, oftentimes the number of available chassis (e.g., the number of unoccupied chassis) in the IHF may not be sufficient to unload all the units in an inbound train. This may be due to the fact that chassis are being used by units waiting to be loaded onto an outbound train, or that more IB units arrive at the IHF than IG units, resulting in a chassis deficit. Moreover, where the number of units processed through the IG unit and loaded onto an outbound train is greater than the number of IB units arriving in a train, a surplus of available chassis may occur, in which chassis may sit without being used. In any case, the imbalance between the IG flow and the IB flow may lead to inefficiencies in the operations of the IHF affecting unit throughput.

Another issue with current IHF operations is due to the current framework for providing chassis resources for IHF operations. Typically, chassis are managed in pools, in which chassis are considered a shared resource that is provided by a chassis provided and shared among several customers. For example, one or more chassis may be provided as a pool by a chassis provided, and one or more customers may have access to the pool. In this example, any one of the one or more customers may make use of any one of the one or more chassis in the pool. When a unit belonging to a pool customer arrives at the IHF, that unit may be unloaded from the train and placed into a chassis belonging to the pool. Oftentimes, the chassis in a pool may not be shared to customers that are not in the pool.

Although chassis pooling provides the advantage of sharing the cost of chassis over several customers, managing the use of the chassis in the IHF creates a very challenging issue. For example, chassis consumption by the customers varies greatly from one customer to another, with some customers using chassis very often and others not as often. In these cases, managing the supply and demand of pool chassis to keep IHF operations efficient is quite the challenge. Many times, chassis allocations may be disparate, and chassis leaving the IHF may not return to the IHF with an IG unit in time, causing surplus and deficit cycles.

This inefficient utilization of chassis not only wastes valuable resources but also impacts the throughput of the IHF. Delays in unit processing can lead to a cascade of disruptions, from congested docking areas to delayed train departures, all of which cumulatively degrade the IHF's service levels and operational efficiency.

### SUMMARY

The present disclosure achieves technical advantages as systems, methods, and computer-readable storage media that provide functionality for optimizing utilization of chassis resources of a hub based on a dual-stream resource optimization (DSRO). In embodiments, the present disclosure provides for a system integrated into a practical application with meaningful limitations as a chassis optimization system with functionality for optimizing utilization of chassis resources in a hub based on a unit traffic prediction in an optimized operating schedule generated using a DSRO, where the unit traffic prediction may include a prediction of containers and chassis expected to arrive at the hub at each time increment of a planning horizon of the optimized operating schedule. The chassis optimization system may optimize the utilization of chassis resources in the hub over the planning horizon by managing the capacity constraints associated with the current chassis resource capacity in the hub over the planning horizon to optimize the use of the current chassis resource capacity to maximize unit throughput through the hub based on the unit traffic prediction and the current chassis resources capacity, and by managing the chassis resource capacity surplus/deficit cycles over the planning horizon to maximize the unit throughput over the planning horizon based on the unit traffic prediction.

In embodiments, the optimized operating schedule may include a consolidated time-space network, over a planning horizon, representing a consolidation stream of units through the hub (e.g., containers on chassis arriving or in-gated (IG) into the hub from customers to be subsequently loaded into outbound trains) and a deconsolidated time-space network, over the planning horizon, representing a deconsolidation stream of units through the hub (e.g., containers arriving to the hub via inbound (IB) trains to be unloaded and placed onto chassis for eventual pickup by customers). In embodiments, the unit traffic prediction of the optimized operating schedule may include a prediction of chassis (e.g., chassis carrying containers) to arrive at the hub through the consolidation operational stream during each time increment of the planning horizon, and an indication of containers to arrive at the hub through the deconsolidation operational stream during each time increment of the planning horizon.

In embodiments, the functionality of the chassis optimization system for managing the capacity constraints associated with the current chassis resource capacity in the hub over the planning horizon to optimize the use of the current chassis resource capacity to maximize unit throughput through the hub based on the unit traffic prediction and the current chassis resources capacity may include functionality of the chassis optimization system to synchronize the consolidation operational stream and the deconsolidation operational stream over the planning horizon. Synchronizing the consolidation operational stream and the deconsolidation operational stream over the planning horizon may include pairing, based on the predicted unit traffic in the optimized operating schedule, ramping events from the consolidation operational stream and deramping events from the deconsolidation operational stream to reconcile the capacity constraints associated with the current chassis resource capacity over the planning horizon.

In embodiments, pairing ramping events from the consolidation operational stream and deramping events form the deconsolidation operational stream may include generating chassis allocation recommendations, over the time increments of the planning horizon, that may include recommended ramping operations that may be performed to free up chassis and deramping operations that may be performed to utilize the freed-up chassis. The chassis allocation recommendations may be included in the optimized operating schedule. In this manner, synchronizing the consolidation operational stream and the deconsolidation operational stream over the planning horizon may operate to leverage the chassis surplus/deficit cycles during the planning horizon created by the imbalance between the IG and IB streams to optimize the use of the current chassis resource capacity in to process a maximum number of units of the units predicted to arrive over the planning horizon given the current chassis resource capacity.

In embodiments, the functionality of the chassis optimization system for managing the chassis resource capacity surplus/deficit cycles over the planning horizon may include functionality for determining chassis resource capacity surplus points and/or chassis resource capacity deficit points over the planning horizon based on the unit traffic prediction and the current chassis resources capacity, which may indicate points (e.g., time increments of the planning horizon) in which the chassis supply of the hub is mismatched with the chassis demand at that point. In embodiments, the functionality of the chassis optimization system for managing the chassis resource capacity surplus/deficit cycles over the planning horizon may include functionality for generating one or more recommendations for managing the chassis resource capacity in the hub over the planning horizon to maximize the unit throughput over the planning horizon based on the unit traffic prediction. The recommendations may include replenishment (e.g., increasing the chassis capacity), repositioning (e.g., shifting the chassis capacity), which may include mismounts (e.g., placing a customer's container on a chassis belonging to a chassis pool to which the customer does not belong), and stacking (e.g., freeing up a chassis from a container by placing the container on a stacked parking lot), etc.

In this manner, the techniques described herein may provide an advantageous result that may allow a system to optimize the management and use of chassis resources within a hub, to ensure that the chassis are allocated to containers efficiently with consideration of not only the unit volume and traffic through the hub over a planning horizon, but also with consideration as to the characteristics of the chassis, which may include chassis pool characteristics, which may ensure that the hub productivity level, such as the unit throughput through the hub, is maximized. Accordingly, the techniques described herein may provide the benefits of allowing a system to plan chassis utilization and/or allocation for the entire length of a planning horizon and to organize future unit moves within the hub that may be impossible to manage and/or organize manually. As a result, hub throughput maximization is achieved.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for optimizing resources in hubs. In doing so, the present disclosure goes well beyond a mere application the manual process to a computer. Accordingly, the claims herein necessarily provide a technological solution that overcomes a technological problem.

In various embodiments, a system may comprise one or more processors interconnected with a memory module, capable of executing machine-readable instructions. These instructions include, but are not limited to, instruction configured to implement the steps outlined in any flow diagram, system diagram, block diagram, and/or process diagram disclosed herein, as well as steps corresponding to a computer program process for implementing any functionality detailed herein, whether or not described with reference to a diagram. However, in typical implementations, implementing features of embodiments of the present disclosure in a computing system may require executing additional program instructions, which may slow down the computing system's performance. To address this problem, the present disclosure includes features that integrate parallel-processing functionality to enhance the solution described herein.

In embodiments, the parallel-processing functionality of systems of embodiments may include executing the machine-readable instructions implementing features of embodiments of the present disclosure by initiating or spawning multiple concurrent computer processes. Each computer process may be configured to execute, process or otherwise handle a designated subset or portion of the machine-readable instructions specific to the disclosure's functionalities. This division of tasks enables parallel processing, multi-processing, and/or multi-threading, allowing multiple operations to be conducted or executed concurrently rather than sequentially. By integrating this parallel-processing functionality into the solution described in the present disclosure, a system markedly increases the overall speed of executing the additional instructions required by the features described herein. This not only mitigates any potential slowdown but also enhances performance beyond traditional systems. Leveraging parallel or concurrent processing substantially reduces the time required to complete sets or subsets of program steps when compared to execution without such processing. This efficiency gain accelerates processing speed and optimizes the use of processor resources, leading to improved performance of the computing system. This enhancement in computational efficiency constitutes a significant technological improvement, as it enhances the functional capabilities of the processors and the system as a whole, representing a practical and tangible technological advancement. The integration of parallel-processing functionality into the features of the present disclosure results in an improvement in the functioning of the one or more processors and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of optimizing utilization of chassis resources of a hub. It is a further object of the disclosure to provide a system for optimizing utilization of chassis resources of a hub, and a computer-based tool for optimizing utilization of chassis resources of a hub. These and other objects are provided by the present disclosure, including at least the following embodiments.

In one particular embodiment, a method of optimizing utilization of chassis resources of a hub is provided. The method includes obtaining an optimized operating schedule including a consolidated time-space network representing a consolidation operational stream and a deconsolidated time-space network representing a deconsolidation operational stream over a planning horizon. In embodiments, the optimized operating schedule includes a unit traffic prediction expected to arrive at the hub at each time increment of a planning horizon of the optimized operating schedule. The method also includes determining one or more capacity constraints associated with the chassis resource capacity of the hub over the planning horizon, synchronizing, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon, including the one or more chassis recommendations to pair chassis supply events with chassis consumption events into the optimized operating schedule, and automatically sending, during execution of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events.

In another embodiment, a system for optimizing utilization of chassis resources of a hub is provided. The train yard management system comprises at least one processor and a memory operably coupled to the at least one processor and storing processor-readable code that, when executed by the at least one processor, is configured to perform operations. The operations include obtaining an optimized operating schedule including a consolidated time-space network representing a consolidation operational stream and a deconsolidated time-space network representing a deconsolidation operational stream over a planning horizon. In embodiments, the optimized operating schedule includes a unit traffic prediction expected to arrive at the hub at each time increment of a planning horizon of the optimized operating schedule. The operations also include determining one or more capacity constraints associated with the chassis resource capacity of the hub over the planning horizon, synchronizing, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon, including the one or more chassis recommendations to pair chassis supply events with chassis consumption events into the optimized operating schedule, and automatically sending, during execution of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events.

In yet another embodiment, a computer-based tool for optimizing utilization of chassis resources of a hub is provided. The computer-based tool including non-transitory computer readable media having stored thereon computer code which, when executed by a processor, causes a computing device to perform operations. The operations include obtaining an optimized operating schedule including a consolidated time-space network representing a consolidation operational stream and a deconsolidated time-space network representing a deconsolidation operational stream over a planning horizon. In embodiments, the optimized operating schedule includes a unit traffic prediction expected to arrive at the hub at each time increment of a planning horizon of the optimized operating schedule. The operations also include determining one or more capacity constraints associated with the chassis resource capacity of the hub over the planning horizon, synchronizing, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon, including the one or more chassis recommendations to pair chassis supply events with chassis consumption events into the optimized operating schedule, and automatically sending, during execution of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for optimizing utilization of chassis resources of a hub based on a dual-stream resource optimization (DSRO) in accordance with embodiments of the present disclosure.

FIG. 2 is a block diagram illustrating an example of a DSRO system configured with capabilities and functionality for optimizing the utilization of chassis resources of a hub based on a DSRO in accordance with embodiments of the present disclosure.

FIG. 3 is a block diagram of an exemplary chassis optimization system configured with functionality for optimizing utilization of chassis resources of a hub based on a DSRO in accordance with embodiments of the present disclosure.

FIG. 4 is a flowchart illustrating operations of a chassis optimization system to synchronize ramping and deramping operations over a planning horizon based on pool characteristics of the chassis resource capacity of a hub to maximize unit throughput of the hub over the planning horizon in accordance with embodiments of the present disclosure.

FIG. 5 shows a high-level flow diagram of operations of a system for providing functionality for optimizing utilization of chassis resources of a hub based on a DSRO in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for optimizing utilization of chassis resources of a hub based on a dual-stream resource optimization (DSRO). In embodiments, the functionality for optimizing utilization of chassis resources of a hub based on a DSRO may include functionality to obtain an optimized operating schedule, which may include a consolidated time-space network, over a planning horizon, representing a consolidation stream of units through the hub (e.g., containers on chassis arriving or in-gated (IG) into the hub from customers to be subsequently loaded into outbound trains) and a deconsolidated time-space network, over the planning horizon, representing a deconsolidation stream of units through the hub (e.g., containers arriving to the hub via inbound (IB) trains to be unloaded and placed onto chassis for eventual pickup by customers). In embodiments, the unit traffic prediction of the optimized operating schedule may include a prediction of chassis (e.g., chassis carrying containers) to arrive at the hub through the consolidation operational stream during each time increment of the planning horizon, and an indication of containers to arrive at the hub through the deconsolidation operational stream during each time increment of the planning horizon.

In embodiments, a chassis optimization system may provide functionality to optimize the utilization of chassis resources in a hub based on the unit traffic prediction in the optimized operating schedule, where the unit traffic prediction may include a prediction of containers and chassis expected to arrive at the hub at each time increment of a planning horizon of the optimized operating schedule. The chassis optimization system may optimize the utilization of chassis resources in the hub over the planning horizon by managing the capacity constraints associated with the current chassis resource capacity in the hub over the planning horizon to optimize the use of the current chassis resource capacity to maximize unit throughput through the hub based on the unit traffic prediction and the current chassis resources capacity, and by managing the chassis resource capacity surplus/deficit cycles over the planning horizon to maximize the unit throughput over the planning horizon based on the unit traffic prediction.

It is noted that the description that follows focuses on operations of a hub (e.g., an intermodal hub facility (IHF), a train yard, etc.) in which units (e.g., containers on chassis carrying goods) received from customers are processed through the hub for eventual loading onto outbound trains to be transported to their respective destinations, and/or received from inbound trains carrying the containers are unloaded onto chassis and placed onto parking lots for eventual pickup by customers. However, the techniques described herein may be applicable in any application in which resources may be used in different operations, and where the use of the resources may be shared by various processes such that optimization of the use of the resources may yield a better throughput for the system.

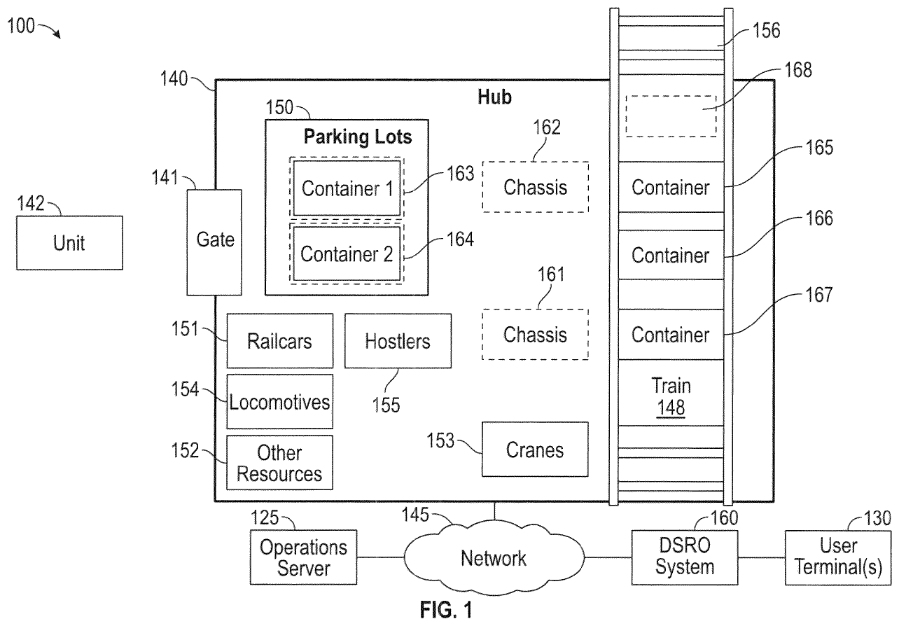

FIG. 1 is a block diagram of an exemplary system 100 configured with capabilities and functionality for optimizing utilization of chassis resources of a hub based on a DSRO in accordance with embodiments of the present disclosure. As shown in FIG. 1, system 100 may include user terminal 130, hub 140, network 145, operations server 125, and DSRO system 160. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide configuration parameters that may be used by system 100 to provide functionality for managing operations of hub 140 in accordance with embodiments of the present disclosure. In embodiments, user terminal 130 may be configured to communicate with other components of system 100.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Hub 140 may represent a hub (e.g., an IHF, a train station, etc.) in which units are processed as part of the transportation of the unit. In embodiments, a unit may include containers, trailers, etc., carrying goods. For example, a unit (e.g., a chassis carrying a container) may be in-gated (IG) into hub 140 (e.g., by a customer dropping the unit into hub 140). The chassis and the container (e.g., the chassis carrying the container) may be temporarily stored in a parking space of parking lots 150, while the container awaits being assigned to an outbound train. Once assigned to an outbound train, and once the outbound train is being processed in the production tracks (e.g., production tracks 156), the chassis with the container is moved to the production tracks, where the container is removed from the chassis and the container is loaded onto the outbound train for transportation to the destination of the container. On the other side of operations, a container carrying goods may arrive at the hub via an inbound (IB) train (e.g., the IB train may represent an outbound train from another hub from which the container may have been loaded), may be unloaded from the IB train onto a chassis, and may be temporarily stored in a parking space of parking lots 150 for eventual pickup by a customer.

In embodiments, processing the units through the IG flow and the IB flow may involve the use of a wide variety of resources to consolidate the containers from customers into departing or outbound trains and/or to deconsolidate arriving or inbound trains into individual units (e.g., containers mounted on chassis) for pickup by customers. These resources may include hub personnel (hostler drivers, crane operators, etc.), parking lots, chassis, hostlers, cranes, tracks, railcars, locomotives, etc. These resources may be used to facilitate moving, storing, loading, unloading, etc. the containers through the operational flows of the hub. For example, parking lots 150 may be used to park or store units (e.g., containers mounted on chassis) while the containers are waiting to be loaded onto departing trains or waiting to be picked up by customers. Chassis 152 (e.g., including semitrailers, frames, etc.), and operators of chassis 152, may be used to securely mount containers while the containers are moved within hub 140. Hostlers 155 (e.g., including hostlers, trucks, forklifts, etc.) and operators of hostlers 155 may be used to transport or move the units (e.g., containers on chassis) within hub 140, such as moving units to be loaded onto an outbound train or to move units unloaded from inbound trains. Cranes 153 may be used to load containers onto departing trains (e.g., to unload units from chassis 152 and load the units onto outbound trains) and/or to unload containers from inbound trains (e.g., to unload units from inbound trains and load the units onto chassis 152). Railcars 151 may be used to transport the units in the train. For example, a train may be composed of one or more railcars, and the units may be loaded onto the railcars for transportation. Inbound trains may include one or more railcars including units that may be processed through the second flow, and outbound trains may include one or more railcars including units that may have been processed through the first flow. Railcars 151 may be assembled together to form a train. Locomotives 154 may include engines that may be used to power a train. Other resources 155 may include other resources not explicitly mentioned herein but configured to allow or facilitate units to be processed through the IG flow and/or the IB flow of operations of hub 140.

Hub 140 may be described functionally by describing the operations of hub 140 as comprising two distinct flows or streams. Units flowing through a first flow (e.g., an IG flow) may be received through gate 141 from various customers for eventual loading onto an appropriate outbound train. For example, customers may drop off individual units (e.g., unit 142 including a container being carried in a chassis) at hub 140. The individual units may be transported by the customers using chassis that may enter hub 140 through gate 141 carrying the units. The containers arriving through the IG flow may be destined for different destinations, and may be dropped off at hub 140 at various times of the day or night. As part of the IG flow, the containers arriving at hub 140, along with the chassis in which these containers arrive, may be assigned or allocated to one or more of parking lots 150, while these containers wait to be assigned to an outbound train bound to the respective destination of the containers. The containers may eventually be loaded onto the assigned outbound train to be taken to their respective destination.

Units flowing through a second flow (e.g., an IB flow) may arrive at hub 140 via an IB train (e.g., train 148 may arrive at hub 140 over railroad 156), carrying containers, such as containers 165, 166, 167, and/or other containers, which may eventually be unloaded from the arriving train to be placed onto chassis, parked in assigned parking spaces of parking lot 150 to be made available for delivery to (e.g., for pickup by) customers.

For example, unit 142, including a container being carried in a chassis, may be currently being dropped off into hub 140 by a customer as part of the IG flow of hub 140, and may be destined to a first destination. In this case, as part of the IG flow, unit 142 may be in-gated into hub 140 and may be assigned to a parking space in one of parking lots 150. In this example, container 1, which may be mounted on chassis 163, may have been introduced into the IG flow of hub 140 by a customer (e.g., the same customer or a different customer) previously dropping off container 1 and chassis 163 at hub 140 to be transported to some destination (e.g., the first destination or a different destination), and may have previously been assigned to a parking lot of parking lots 150, where container 1 may currently be waiting to be assigned and/or loaded onto an outbound train to be transported to the destination of container 1.

As part of the IG flow, the container in unit 142 and container 1 may be assigned to an outbound train. For example, in this particular example, train 148 may represent an outbound train that is schedule to depart hub 140 to the same destination as the container in unit 142 and container 1. In this example, the container in unit 142 and container 1 may be assigned to train 148. Train 148 may be placed on one of one or more production tracks 156 to be loaded. In this case, as part of the IG flow, train 148 is loaded (e.g., using one or more cranes 153) with containers, including the container in unit 142 and container 1. Once loaded, train 148 may depart to its destination as part of the IG flow.

With respect to the IB flow, train 148 may arrive at hub 140 carrying several containers, including containers 2 and 165-167. It is noted that, as part of the dual stream operations of hub 140, some resources are shared and, in this example, train 148 may arrive at hub 140 as part of the IB flow before being loaded with containers as part of the IG flow as described above. Train 148 may be placed on placed on one of one or more production tracks 156 to be unloaded a part of the IB flow. As part of the unloading operations, the containers being carried by train 148 and destined for hub 140, may be removed from train 148 (e.g., using one or more cranes 153) and each placed or mounted on a chassis. Once on the chassis, the containers are transported (e.g., using one or more hostlers 155) to an assigned parking space of parking lots 150 to wait to be picked up by respective customers at which point the containers and the chassis on which the containers are mounted may exit or leave hub 140.

In embodiments, operations server 125 may be configured to provide functionality for facilitating operations of hub 140. In embodiments, operations server 125 may include data and information related to operations of hub 140, such as current inventory of all hub resources (e.g., chassis, hostlers, drivers, lift capacity, parking lot and parking spaces, IG capacity limits, railcar, locomotives, tracks, etc.). This hub resource information included in operations server 125 may change over time as resources are consumed, replaced, and/or replenished, and operations server 125 may have functionality to update the information. Operations server 125 may include data and information related to inbound and/or outbound train schedules (e.g., arriving times, departure times, destinations, origins, capacity, available spots, inventory list of units arriving in inbound trains, etc.). In particular, inbound train schedules may provide information related to inbound trains that are scheduled to arrive at the hub during the planning horizon, which may include scheduled arrival time, origin of the inbound train, capacity of the inbound train, a list of units loaded onto the inbound train, a list of units in the inbound train destined for the hub (e.g., to be dropped off at the hub), etc. With respect to outbound train schedules, the outbound train schedules may provide information related to outbound trains that are scheduled to depart from the hub during the planning horizon, including scheduled departure time, capacity of the outbound train, a list of units already scheduled to be loaded onto the outbound train, destination of the outbound train, etc. In embodiment, the information from operations server 125 may be used (e.g., by DSRO system 160) to develop and/or update an optimized operating schedule based on a DSRO for managing the resources of hub 140 over a planning horizon.

In embodiments, operations server 125 may provide functionality to manage the execution of the operational schedule (e.g., an optimized operating schedule in accordance with embodiments of the present disclosure) over the planning horizon of the operating schedule. The optimized operating schedule may represent recommendations made by DSRO system 160 of how units arriving at each time increment of the planning horizon are to be processed, and how resources of hub 140 are to be managed to maximize unit throughput through the hub over the planning horizon of the optimized operating schedule. Particular to the present disclosure, the optimized operating schedule may include recommendations associated with the utilization of chassis resources (e.g., associated with chassis allocations) for performing ramping and deramping operations.

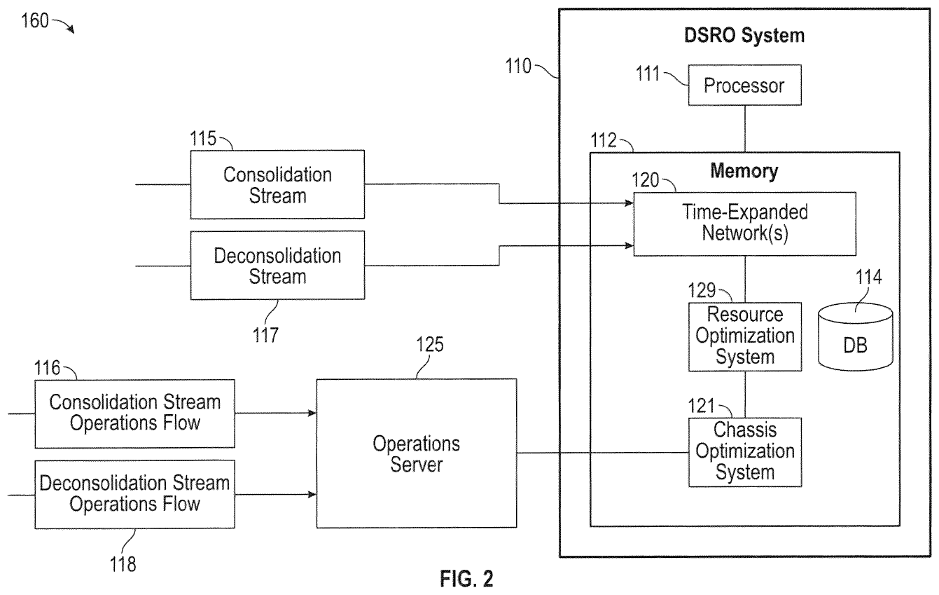

In embodiments, operations server 125 may manage execution of the optimized operational schedule by monitoring the consolidation stream operations flow (e.g., consolidation stream operations flow 116 of FIG. 2, which may represent the actual unit traffic flow through the IG flow during execution of the optimized operating schedule) and deconsolidation stream operations flow (e.g., deconsolidation stream operations flow 118 of FIG. 2, which may represent the actual unit traffic flow through the IB flow during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule.

In embodiments, operations server 125 may operate to provide functionality that may be leveraged during execution of the optimized operational schedule over a planning horizon to ensure that unit throughput through the hub is maximized over the planning horizon. This functionality of operations server 125 may include functionality to allocate chassis to arriving containers (e.g., containers being unloaded from an IB train) and/or to perform particular ramping and/or deramping operations in accordance and/or based on the optimized operating schedule over the planning horizon. In embodiments, operations server 125 may include functionality to ensure that the optimized operating schedule is updated based on actual operations, such as based on actual resource consumption.

DSRO system 160 may be configured to manage resources of hub 140 based on a DSRO to maximize throughput through hub 140 in accordance with embodiments of the present disclosure. In particular, DSRO system 160 may be configured to provide the main functionality of system 100 to optimize the utilization of chassis resources of hub 140 based on a DSRO such that ramping operations of the IG flow and deramping operations of the IB flow are synchronized based on an optimized operating schedule over a planning horizon to maximize the unit throughput of hub 140 over the planning horizon based on the predicted unit traffic and the predicted chassis resource capacity, and to manage the chassis resource capacity surplus/deficit cycles of hub 140 over the planning horizon, which may include recommendations to replenish, reposition, mismount, etc. the current chassis resource capacity, to maximize the unit throughput over the planning horizon based on the unit traffic prediction.

In embodiments, DSRO system 160 may optimize the utilization of chassis resources of hub 140 over the planning horizon of an optimized operating schedule by leveraging the functionality of a chassis optimization system (e.g., chassis optimization system 121 of FIG. 2) that may include functionality to synchronize the ramping operations of the IG flow and deramping operations of the IB flow, and to manage the chassis resource capacity surplus/deficit cycles of hub 140 over the planning horizon.

FIG. 2 is a block diagram illustrating an example of DSRO system 160 configured with capabilities and functionality for optimizing the utilization of chassis resources of a hub based on a DSRO in accordance with embodiments of the present disclosure. As shown in FIG. 2, DSRO system 160 may be implemented in a server (e.g., server 110). In embodiments, functionality of server 110 to facilitate operations of DSRO system 160 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, time-expanded network 120, chassis optimization system 121, resources optimization system 129, and database 114. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of DSRO system 160. In embodiments, database 114 may store information related to various models used during operations of DSRO system 160, such as a DSRO model, a chassis optimization model, etc. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

As mentioned above, operations of hub 140 may be represented as two distinct flows, an IG flow in which units arriving to hub 140 from customers are consolidated into outbound trains to be transported to their respective destinations, and an IB flow in which inbound trains arriving to hub 140 carrying units are deconsolidated into the units that are stored in parking lots while waiting to be picked up by respective customers. DSRO system 160 may be configured to represent the IG flow as consolidation stream 115 including a plurality of stages. Each stage of consolidation stream 115 may represent different operations or events that may be performed or occur to facilitate the IG flow of hub 140. DSRO system 160 may be configured to represent the IB flow as deconsolidation stream 117 including a plurality of stages. Each stage of deconsolidation stream 117 may represent different operations or events that may be performed or occur to facilitate the IB flow of hub 140.

Each of the consolidation stream 115 and deconsolidation stream 117 may include various stages. For example, consolidation stream 115 may be configured to include a plurality of stages, namely an in-gated (IG) stage, an assignment (AS) stage, a ramping (RM) stage, a release (RL) stage, and a departure (TD) stage. Deconsolidation stream 115 may be configured to include a plurality of stages, namely an arrival (TA) stage, a strip track placement (ST-PU) stage, a de-ramping (DR) stage, a unit park and notification (PN) stage, and an out-gated (OG) stage. In embodiments, each of the stages of each of consolidation stream 115 and deconsolidation stream 117 may represent an event or operations that may be performed or occur to facilitate the flow of a unit through each of the streams.

In particular, the RM stage of consolidation stream 115 may represent ramping operations of the IG flow in which containers may be loaded onto an outbound train for transportation to the destination of the container. In embodiment, during the RM stage, the container may be assigned to a railcar of an outbound train, such as based on the unit's destination and/or the desired delivery time, such as based on a scheduled train lineup. In particular embodiments, the RM stage of consolidation stream 115 may operate to consolidate containers with a same destination (or with a destination that is within a particular route) into a single outbound train based on their destination. During the RM stage of consolidation stream 115, a container may be transported on a chassis (e.g., from a parking space by a hostler) to the production track in which the outbound train is being loaded. The container may then be removed from the chassis and loaded onto the assigned railcar. In this case, loading the container onto the railcar may release the chassis (e.g., making the chassis available to receive another container).

In embodiments, the RM stage of deconsolidation stream 117 may represent deramping operations of the IB flow. During the DR stage, containers arriving to the hub in an inbound train may be unloaded onto allocated chassis. In embodiments, unloading (e.g., or deramping) the containers from the inbound train during the DR stage of deconsolidation stream 117 may consume a chassis, which may then be parked or stored in a parking lot while the container waits to be picked up by a customer during the PN and OG stages.

In embodiments, the interaction between consolidation stream 115 and deconsolidation stream 117, with respect to the use of resources of hub 140, may be collaborative or competing. For example, parking spaces of parking lots 150 may be used to store units flowing through the AS stage of consolidation stream 115 while the units are waiting to be ramped (e.g., processed through the RM stage). However, parking spaces of parking lots 150 may also be used to store units processed through the DR stage of deconsolidation stream 117 (e.g., units unloaded from an inbound train), while these units are waiting to be picked up by a customer (e.g., while being processed through the PN stage). In this manner, consolidation stream 115 and deconsolidation stream 117 may compete for the use of parking lots 150 within hub 140.

In embodiments, consolidation stream 115 and deconsolidation stream 117 may, in some situations, compete for the hub resources, and, in other situation, may complement each other (e.g., may collaborate) in the use of the resources. For example, parking lots 150 (e.g., as illustrated in FIG. 1) including parking spaces may be used to park or store units (e.g., containers mounted on chassis, or stacked containers) being processed through the AS stage of consolidation stream 115 while these units are waiting to be loaded onto an outbound train. However, parking lots 150 including parking spaces may also be used to park or store units (e.g., containers mounted on chassis, or stacked containers) processed through the DR and PN stages of deconsolidation stream 117 while these units are waiting to be picked up by a customer. In this manner, consolidation stream 115 and deconsolidation stream 117 of the hub operations may compete for the use of parking lot resources within the hub.

In another example, the utilization of chassis resources within hub 140 between consolidation stream 115 and deconsolidation stream 117 may be collaborative. For example, containers dropped off at hub 140 by customers are typically dropped off on a chassis. In this manner, when a container enters hub 140 through consolidation stream 115, an additional chassis is added to the chassis resource capacity of hub 140. In this case, the additional chassis may be used by the container and as such may not be available, but the chassis may nonetheless be part of the chassis capacity of hub 140 since the additional chassis may become available and be used to receive a container once the container is removed from the chassis and loaded onto an outbound train. For example, chassis 163 may currently be occupied by container 1, and may be parked in one of parking lots 150 after having been dropped off by a customer, and may be waiting for container 1 to be assigned and/or loaded onto an outbound train. As chassis 163 is occupied, chassis 163 may not be available to receive another container, even if chassis 163 is part of the chassis resource capacity of hub 140. Once container 1 is loaded onto an outbound train as part of the RM stage of consolidation stream 115 freeing up chassis 163, chassis 163 may be available to receive another container. Therefore, consolidation stream 115, and specifically the RM stage of consolidation stream 115, operates to supply or increase chassis resources to the chassis resource capacity of hub 140.

From deconsolidation stream 117's perspective, containers arriving at hub 140 may require a chassis upon which to be mounted before the containers may be unloaded from the inbound train at the DR stage of deconsolidation stream 117. The chassis used to receive an unloaded container is used from the current chassis resource capacity of hub 140 and once a container is placed or mounted on a chassis, the chassis is no longer available to receive another container. For example, train 148 may be an inbound train and may arrive at hub 140 carrying containers 2 and 165-167. In this example, chassis 164 may be used to receive container 2, chassis 162 may be used to receive container 165, and chassis 161 may be used to receive container 167. Once the containers are loaded onto their corresponding chassis at the DR stage of deconsolidation stream 117, the containers are stored or parked in one or more of parking lots 150. Therefore, deconsolidation stream 117, and specifically the DR stage of deconsolidation stream 117, operates to consume or decrease chassis resources from the chassis resource capacity of hub 140.

From the foregoing, it is noted that consolidation stream 115 supplies chassis resources and deconsolidation stream 117 consumes chassis resources and as such, consolidation stream 115 and deconsolidation stream 117, specifically the ramping operations at the RM stage of consolidation stream 115 and the deramping operations at the DR stage of deconsolidation stream 117, have a collaborative relationship in which one supplies resources and the other consumes the supplied resources. In this case, the capacity constraints of the chassis resources within hub 140 may create a big challenge in managing the chassis resources efficiently so that the unit throughput of hub 140 is not affected negatively.

In embodiments, DSRO system 160 may be configured to optimize the use of chassis resources to maximize the unit throughput of the hub (e.g., the rate of units processed through the hub) over a planning horizon of an optimized operating schedule by generating one or more time-space networks 120 to represent consolidation stream 115 and deconsolidation stream 117, and configuring the DSRO model to use one or more time-space networks 120, over a planning horizon, to optimize the use of the resources of the hub that support the unit flow within the planning horizon to maximize the throughput over the planning horizon. In embodiments, the DSRO model may generate, based on the one or more time-space networks 120, an optimized operating schedule that includes one or more of a determined or predicted unit flow through one or more of the stages of each time-space network (e.g., the consolidation and/or deconsolidation stream time-space networks) at each time increment of the planning horizon, an indication of a resource deficit or surplus at one or more of the stages of each time-space network at each time increment of the planning horizon, and/or an indication or recommendation of a resource replenishment to be performed at one or more of the stages of each time-space network at each time increment of the planning horizon to increase the unit throughput of the hub. Particular to the present disclosure, the optimized operating schedule may include recommendations for ramping and/or deramping operations to synchronize consolidation stream 115 and deconsolidation stream 117 to ensure that the chassis resource supply of consolidation stream 115 and the chassis resource consumption of deconsolidation stream 117 is paired to maximize the unit throughput of the hub over the planning horizon.

In embodiments, DSRO system 160 may generate one or more time-space networks 120 using the stages of consolidation stream 115 and deconsolidation stream 117. In particular, DSRO system 160 may define the nodes of a time-space network to represent the stages of the corresponding stream, and the edges between the nodes to represent the capacity. The time increment of the time-space networks may be variable and configurable, and may represent, for example, a particular timeframe, such as an hour, a multi-hour block, a shift, etc. Although consolidation stream 115 and deconsolidation stream 117 may appear to operate independently, there is a resource interdependency between both streams that intertwines them at every stage. The DSRO model of embodiments may model not only both streams, but their resource interdependency and may leverage this configuration to optimize the resource utilization of both streams to maximize throughput over the planning horizon.

In embodiments, DSRO system 160 may be configured to apply the generated DSRO model to the time-expanded networks 120 to optimize the use of the resources (e.g., chassis resources) by the consolidation and deconsolidation streams over the planning horizon to maximize throughput of the hub over the planning horizon. To that end, DSRO 160 may include a plurality of optimization systems. For example, resource optimization system 129 may be configured to generate, based on the DSRO model, an optimized operating schedule that may be implemented over a planning horizon to maximize throughput of units through the hub. In particular, resource optimization manager 129 may be configured to consider resource availability (e.g., resource inventory), resource replenishment cycles, resource cost, operational implications of inadequate supply of resources, for all the resources involved in the consolidation and deconsolidation streams to determine the optimized operating schedule that may maximize throughput through the hub over the planning horizon. Resource optimization manager 129 may be configured to additionally consider unit volumes (e.g., unit volumes expected to flow during the planning horizon through the consolidation stream and the deconsolidation streams, such as at each time increment of the planning horizon) and unit dwell times (e.g., expected dwell times of units flowing through the consolidation stream and the deconsolidation streams during the planning horizon) to determine the optimized operating schedule that may maximize throughput through the hub over the planning horizon.

During operations (e.g., during execution of the operating schedule, when units arrive at the hub), operations server 125 may operate to manage execution of the optimized operational schedule by monitoring consolidation stream operations flow 116 (e.g., representing the actual traffic flow through the consolidation stream 115 during execution of the optimized operating schedule) and deconsolidation stream operations flow 118 (e.g., representing the actual traffic flow through the deconsolidation stream 117 during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule.

In embodiments, the functionality of DSRO system 160 to optimize the utilization of chassis resources may include leveraging the functionality of chassis optimization system 121. Chassis optimization system 121 may operate to provide further optimization of hub operations by managing the capacity constraints associated with the current chassis resource capacity in the hub over the planning horizon to optimize the use of the current chassis resource capacity to maximize unit throughput through the hub based on the unit traffic prediction and the current chassis resources capacity, and by managing the chassis resource capacity surplus/deficit cycles over the planning horizon to maximize the unit throughput over the planning horizon based on the unit traffic prediction.

For example, in embodiments, chassis optimization system 121 may be configured to manage the capacity constraints associated with the current chassis resource capacity in the hub over the planning horizon to optimize the use of the current chassis resource capacity to maximize unit throughput through the hub based on the unit traffic prediction and the current chassis resources capacity by synchronizing operations of consolidation stream 115 and operations of deconsolidation stream 117 over the planning horizon. Synchronizing operations of consolidation stream 115 and operations of deconsolidation stream 117 over the planning horizon may include pairing, based on the predicted unit traffic in the optimized operating schedule, ramping events from the consolidation operational stream and deramping events from the deconsolidation operational stream to reconcile the capacity constraints associated with the current chassis resource capacity over the planning horizon, in order to coordinate the supply and consumption of chassis resources over the planning horizon to maximize unit throughput with the current chassis resource capacity of the hub. In this manner, chassis optimization system 121 may be configured to maximize the number of units processed through the hub over the planning horizon given the unit traffic (e.g., the units expected to arrive at the hub through each of the IG and IB flows at each time increment of the planning horizon) predicted in the optimized operating schedule and given the current chassis capacity of the hub (e.g., given the number of chassis expected or predicted to be present within the hub over the planning horizon).

In embodiments, chassis optimization system 121 may be configured to manage the chassis resource capacity surplus/deficit cycles over the planning horizon by determining chassis resource capacity surplus points and/or chassis resource capacity deficit points over the planning horizon based on the unit traffic prediction and the current chassis resources capacity, which may indicate points (e.g., time increments of the planning horizon) in which the chassis supply of the hub is mismatched with the chassis demand at that point. The mismatch may indicate a chassis surplus (e.g., there are more chassis available (e.g., freed-up) than needed for containers, which may be due to the type, size, pool, customer, etc. associated with the container and/or chassis) or a chassis deficit (e.g., there are not enough chassis available (e.g., freed-up) for the containers needing a chassis, which may be due to the type, size, pool, customer, etc. associated with the container and/or chassis). In embodiments, chassis optimization system 121 may generate one or more recommendations for managing the chassis resource capacity in the hub over the planning horizon to maximize the unit throughput over the planning horizon based on the unit traffic prediction. The recommendations may include replenishment (e.g., increasing the chassis capacity), repositioning (e.g., shifting the chassis capacity), which may include mismounts (e.g., placing a customer's container on a chassis belonging to a chassis pool to which the customer does not belong), and stacking (e.g., freeing up a chassis from a container by placing the container on a stacked parking lot), etc. In this manner, chassis optimization system 121 may be configured to provide recommendations to increase or reposition the current chassis resource capacity of the hub to further maximize the number of units processed through the hub over the planning horizon given the unit traffic (e.g., the units expected to arrive at the hub through each of the IG and IB flows at each time increment of the planning horizon) predicted in the optimized operating schedule and given the replenished or repositioned chassis resource capacity of the hub.

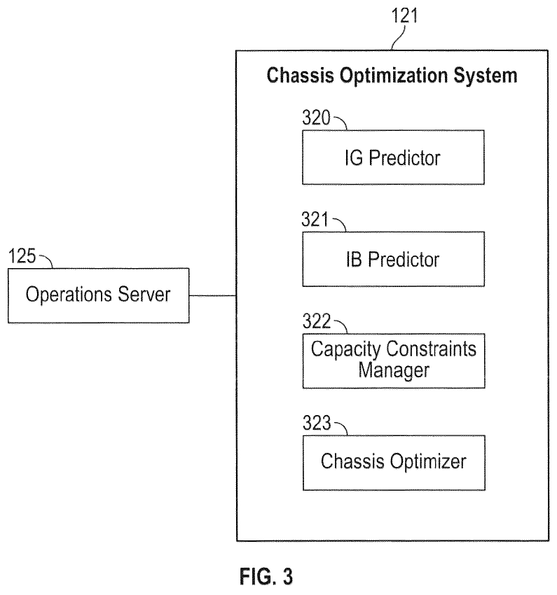

Operations of chassis optimization system 121 will now be discussed with respect to FIG. 3. FIG. 3 is a block diagram of an exemplary chassis optimization system 121 configured with functionality for optimizing utilization of chassis resources of a hub based on a DSRO in accordance with embodiments of the present disclosure. As shown in FIG. 3, chassis optimization system 121 may include IG predictor 320, IB predictor 321, capacity constraints manager 322, and chassis optimizer 323.

IG predictor 320 may be configured to determine or predict the unit traffic flow through the consolidation stream over the planning horizon of the optimized operating schedule. IB predictor 321 may be configured to determine or predict the unit traffic flow through the deconsolidation stream over the planning horizon of the optimized operating schedule. In embodiments, determining the traffic flow through each stream (e.g., each of the consolidation stream and/or the deconsolidation stream) may include a determination as to the number of units (e.g., unit volume) expected at each time increment of the planning horizon over each of the stream. In embodiments, the unit traffic flow prediction through the consolidation stream may be used by chassis optimization system 121 to determine the number of chassis that may be added, at each time increment of the planning horizon, to the current chassis resource capacity of the hub, as the units arriving to the hub through the consolidation stream include a container transported on a chassis, and this chassis is added to the chassis resource capacity of the hub. On the other hand, the unit traffic flow prediction through the deconsolidation stream may be used by chassis optimization system 121 to determine the number of chassis that may be subtracted, at each time increment of the planning horizon, from the current chassis resource capacity of the hub, as containers may be removed from the hub by customers on chassis.

In embodiments, the unit traffic flow prediction through the consolidation stream may be used by chassis optimization system 121 to determine the number of chassis in the current chassis resource capacity that may be made available to receive a container unloaded from an inbound train as part of the deconsolidation stream. For example, the unit traffic flow prediction through the consolidation stream may indicate, at each time increment, a number of units that may be processed through the ramping stage, since IG predictor may determine (e.g., based on active train schedules, goal time for the various containers, etc. from operations server 125) containers that may be ramped at each time increment of the planning horizon. These units may release a chassis and as such, chassis optimization system 121 may determine the number of chassis that may be made available. On the other hand, the unit traffic flow prediction through the deconsolidation stream may be used by chassis optimization system 121 to determine the number of containers arriving at the hub at each time increment of the planning horizon and to determine a number of chassis required to receive each of the arriving containers.

Based on the unit traffic prediction from IG predictor 320 and IB predictor 321, chassis optimization system 121 may determine a unit traffic volume and a current chassis resource capacity prediction for each time increment of the planning horizon. Based on this data, chassis optimization system 121 may synchronize the ramping and deramping operations to ensure that the unit throughput of the hub is maximized. In this, chassis optimization system 121 may pair the ramping events to the deramping events to ensure that the chassis made available by the ramping events are used efficiently by the deramping events, and to ensure that chassis are available for the deramping events.

In embodiments, pairing ramping events to deramping events may include generating chassis allocation recommendations over the planning horizon. For example, chassis optimization system 121 may pair a ramping event to a deramping event by generating a recommendation to ramp a particular container mounted on a chassis onto an outbound train, making a chassis available, and to deramp a container arriving in an inbound train onto the chassis made available by the ramping event. The recommendations of chassis optimization system 121 may take into account the entire planning horizon, and the ramping and deramping events may occur or be performed at different time increments of the planning horizon.

Capacity constraints manager 322 may be configured to provide functionality for chassis optimization system 121 to manage the capacity constraints associated with the chassis resource capacity in the hub when synchronizing the ramping and deramping operations over the planning horizon to ensure that the unit throughput of the hub is maximized. In this, capacity constraints manager 322 may consider the capacity constraints of the chassis resource capacity of the hub and may, based on the capacity constraints, generate, in cooperation with the chassis optimizer 323, chassis allocation recommendations at each time increment of the planning horizon to optimize the chassis utilization to maximize unit throughput based on the capacity constraints.

In embodiments, the capacity constraints of the chassis resource capacity may include a constraint due to the collaborative relationship between the ramping and deramping operations consolidation stream 115 and deconsolidation stream 117, respectively. Under this capacity constraint, a chassis currently used by a container being processed through consolidation stream 115 may not be available to be used to deramp a container being processed through deconsolidation stream 117 until the container is ramped onto a train and the chassis is freed-up. Capacity constraints manager 322 may consider this constraint when enabling chassis optimization system 121 to synchronize the ramping and deramping operations over the planning horizon.

For example, with reference back the example illustrated in FIG. 1, train 148 may arrive as an inbound train to hub 140, carrying containers 2 and 165-167, as part of the deconsolidation stream of hub 140. In the meantime, container 1 may be occupying chassis 164 and may be parked on parking lots 150 waiting to be assigned and/or loaded onto an outgoing train as part of the consolidation stream of hub 140. In this case, for train 148 to be unloaded, sufficient chassis need to be available to accommodate each of the containers to be unloaded from train 148. For example, a chassis needs to be available for each of containers 2 and 165-167 to be unloaded onto the respective chassis during the deramping stage of the deconsolidation stream of hub 140. Without an available chassis, a container cannot be unloaded from train 148. In this example, the current chassis capacity of hub 140 may include chassis 161-164 as well as the chassis carrying unit 142. However, capacity constraints manager 322 may determine that, until container 1 is ramped onto an outbound train, chassis 163 is not available to receive another container. In addition, unit 142 includes a chassis that is being in-gated into hub 140, but the cassis is occupied by the container. In embodiments, capacity constraints manager 322 may determine that the chassis carrying the container of unit 142 is not available to receive another container until the container is ramped onto an outbound train. In embodiments, chassis optimization system 121 may synchronize ramping operations, which may include ramping of container 1 and unit 142 onto an outbound train to free-up chassis, and deramping operations (e.g., which may include deramping of containers 2 and 165-167), which may consume available chassis, based on the capacity constraints determined by capacity constraints manager 322 (e.g., with respect to availability of the chassis) to ensure that unit throughput is maximized given the current chassis capacity and the number of units being processed over the planning horizon. In this manner, chassis optimization system 121 may determine time increments of the planning horizon where chassis resource supply may be generated and may determine time increments of the planning horizon where chassis resource consumption may be fulfilled over the planning horizon by reconciling the consolidation and deconsolidation streams.

In embodiments, the capacity constraints of the chassis resource capacity may include characteristics of the chassis in the chassis capacity of the hub. The characteristics of the chassis in the current chassis capacity of the hub may include the type, size, chassis pool characteristics, availability, etc. of the chassis. The characteristics of the chassis in the current chassis capacity of the hub may affect the management of the current chassis resource capacity (e.g., may affect where or how the chassis may be used) because the characteristics of the chassis in the current chassis capacity of the hub may prevent a chassis from being used to receive a particular container. For example, capacity constraints manager 322 may consider the type and/or size of a chassis, and/or whether the chassis is available, when determining whether the chassis can be used to receive another container. For example, a chassis of a particular type and/or size may be incompatible with a container, in which case the chassis cannot be used to receive the container. In another example, a chassis that is unavailable cannot be used to receive a container.

In embodiments, the characteristics of a chassis may include the chassis pool characteristics of the chassis. For example, as noted above, chassis resources of a hub (e.g., hub 140) are typically structured as chassis pools. A chassis pool may include one or more chassis belonging to a particular chassis pool supplier. Customers may sign up to be part of the pool, in which case, chassis pool customers may enjoy the right to use any one of the chassis in the chassis pool. However, non-chassis pool customers (e.g., customers not belonging to the chassis pool) may not use the chassis in the chassis pool. Since typical hub operations may involve a significant number of chassis pools with a significant number of chassis being used by a significant number of customers, managing the allocation of the chassis in the chassis pools to ensure that a chassis is used by the right customer (e.g., by a customer belonging to the chassis pool that the chassis belongs and not by a customer not belonging to the chassis pool), that chassis pool chassis are available to receive a container from a chassis pool customer, etc., can be very challenging.

In embodiments, capacity constraints manager 322 may consider the pool characteristics when enabling chassis optimization system 121 to synchronize the ramping and deramping operations over the planning horizon to maximize the unit throughput of the hub. The chassis pool characteristics of a chassis may include whether the chassis belongs to a closed chassis pool (e.g., a pool that does not permit non-pool customers from using a chassis from the pool at all), an open chassis pool (e.g., a pool that permits non-pool customers from using a chassis from the pool in some circumstances, but the chassis is not permitted to leave the hub with the non-pool customer container), the chassis pool customers, the chassis pool chassis, etc. Chassis optimization system 121 may synchronize the ramping and deramping operations over the planning horizon based on the pool characteristics of the chassis resource capacity of the hub to ensure that the utilization of the chassis pool resources results in a maximized unit throughput of the hub over the planning horizon.

In embodiments, chassis optimization system 121 may determine, when optimizing the utilization of the chassis over the planning horizon, whether stacking containers in order to free up chassis may result in optimization over the planning horizon. In some embodiments, the chassis optimization system may determine to recommend stacking containers when the containers are determined to have a long-dwelling time and chassis capacity is below some thresholds.

In embodiments, chassis optimization system 121 may determine, when optimizing the utilization of the chassis over the planning horizon, to recommend mismounts (e.g., placing a customer's container in a chassis that is not part of a pool to which the customer has access), in response to a determination that the chassis used may not be used to support a container from a customer in the chassis pool before the end of the planning horizon, or in response to a determination that the chassis used may be flipped (e.g., may be freed up from the mismounted container) and made available to be used for a container from a customer in the chassis pool before the end of the planning horizon.

Chassis optimizer 323 may be configured to generate chassis allocation recommendations at each time increment of the planning horizon to optimize the chassis utilization to maximize unit throughput based on the capacity constraints. For example, chassis optimizer may be configured to include chassis allocation recommendations at each time increment of the planning horizon in the optimized operating schedule.

In embodiments, chassis optimizer 323 may be configured to manage the chassis resource capacity surplus/deficit cycles over the planning horizon. In embodiments, chassis optimizer 323 may be configured to determine chassis resource capacity surplus points and/or chassis resource capacity deficit points over the planning horizon based on the unit traffic prediction and the current chassis resources capacity. The unit traffic prediction (e.g., the number of units predicted to be processed at each stage of the consolidation and deconsolidation streams at each increment of the planning horizon) and the chassis resources capacity of the hub (e.g., the predicted chassis resource capacity at each time increment of the planning horizon) may indicate points (e.g., time increments of the planning horizon) in which the chassis supply of the hub is mismatched with the chassis demand at that point. The mismatch may indicate a chassis surplus (e.g., there may be more chassis available (e.g., freed-up) than needed for containers, which may be due to the type, size, pool, customer, etc. associated with the container and/or chassis) or a chassis deficit (e.g., there are not enough chassis available (e.g., freed-up) for the containers needing a chassis, which may be due to the type, size, pool, customer, etc. associated with the container and/or chassis).

In embodiments, chassis optimizer 323 may generate, based on the determined chassis resource capacity surplus/deficit cycles over the planning horizon, one or more recommendations for managing the chassis resource capacity in the hub over the planning horizon to maximize the unit throughput over the planning horizon based on the unit traffic prediction. The recommendations may include replenishing the chassis resource capacity. Replenishment recommendation may include recommendations to increase the chassis capacity of the hub, such as by bringing more chassis into the hub. The recommendations may include recommendations to reposition the chassis resource capacity. Repositioning the chassis resource capacity may include moving the chassis to other locations (e.g., other areas of the hub or even other hubs) where a chassis deficit may be present. In some embodiments, chassis resource capacity surplus/deficit events may be managed by mismounting a chassis, in which a customer's container may be placed on a chassis belonging to a chassis pool to which the customer does not belong in order to make use of the chassis when there may be a surplus of chassis in that pool. In some embodiments, chassis resource capacity surplus/deficit events may be managed by stacking, which may include freeing up a chassis from a container by placing the container on a stacked parking lot.

In embodiments, operations server 125 may be configured to automatically send, during executing of the optimized operating schedule, a control signal to a controller configured to cause a first container to be removed from a chassis as part of a ramping operation and to cause a second container to be placed onto the chassis as part of a deramping operation in accordance with the one or more chassis recommendations to pair chassis supply events with chassis consumption events.

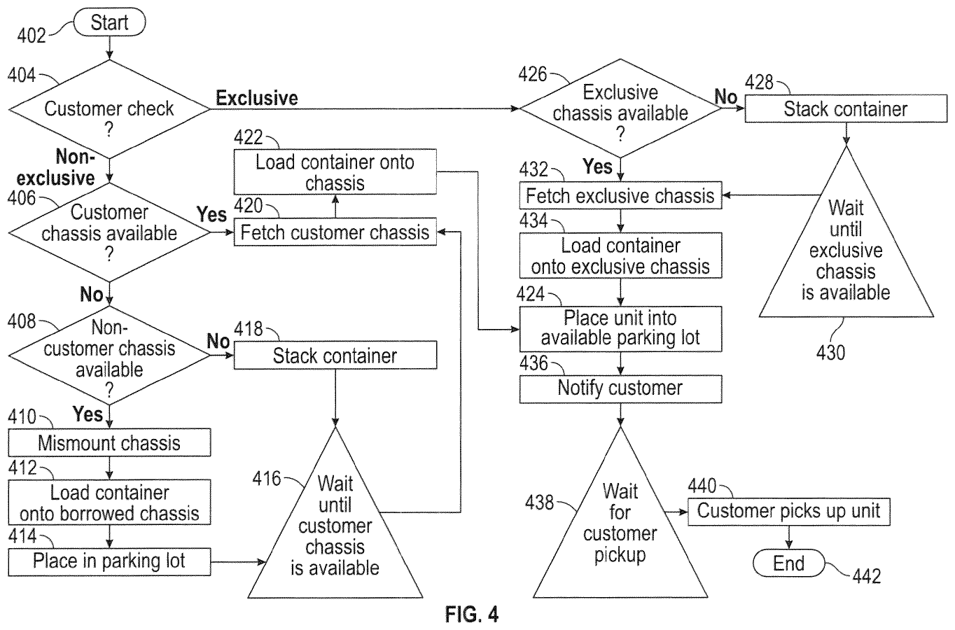

FIG. 4 is a flowchart illustrating operations of a chassis optimization system (e.g., chassis optimization system 121) to synchronize ramping and deramping operations over a planning horizon based on pool characteristics of the chassis resource capacity of a hub to maximize unit throughput of the hub over the planning horizon in accordance with embodiments of the present disclosure. Operations illustrated in FIG. 4 assume a current chassis capacity of the hub, and are part of an optimized operating schedule being executed over a planning horizon. The operations illustrated in FIG. 4 may be used by chassis optimization system 121 to allocate a chassis to a container based on the pool characteristics of the current chassis capacity of the hub.

As shown in FIG. 4, operations of chassis optimization system 121 may start at block 402 where a container belonging to a customer may be received at the hub (e.g., hub 140 as illustrated in FIG. 1) in an inbound train. The container may be received as part of the IB flow or deconsolidation stream of the hub, and may require a chassis allocation for receiving the container before the container can be unloaded or deramped from the inbound train. In embodiments, at block 404, a determination is made as to whether the container belongs to an exclusive customer. In embodiments, an exclusive customer is one that permits a container to be loaded or placed only on a chassis that belongs exclusively to the exclusive customer. As such, a container belonging to an exclusive customer may only be allocated to a chassis that belongs to the exclusive customer, and may not be allocated to a chassis that does not belong to the exclusive customer.

Upon a determination, at block 404, that the container belongs to an exclusive customer, at block 426, a determination is made as to whether a chassis belonging to the exclusive customer is currently available. In response to a determination that a chassis belonging to the exclusive customer is not currently available, chassis optimization system 121 may determine to recommend that the container be stored in a stacked parking lot. In this case, the container may be placed in a container stack (e.g., one container on top of each other, and sitting on the ground or a platform instead of a chassis) instead of being placed on a chassis and in a parking lot space, and may wait, at block 430, in the stacked parking lot until an exclusive chassis is available (e.g., from a deramping event, from a replenishment event, etc.). Once an exclusive chassis is available for the container, operations flow to block 432.

On the other hand, in response to a determination that a chassis belonging to the exclusive customer is currently available, the chassis belonging to the exclusive customer may be fetched at block 432, and the container may be placed onto the exclusive chassis at block 434. At block 424, the container mounted on the exclusive chassis may be placed on a parking space of a parking lot of the hub to wait for pickup by the exclusive customer.

Referring back to block 404, in response to a determination that the container does not belong to an exclusive customer, at block 406, a determination is made as to whether a chassis belonging to the pool to which the customer belongs is available. In response to a determination that a chassis belonging to the pool to which the customer belongs is available, the chassis belonging to the pool to which the customer belongs may be fetched at block 420, and the container may be placed onto the pool chassis at block 422. At block 424, the container mounted on the pool chassis may be placed on a parking space of a parking lot of the hub to wait for pickup by the customer.

On the other hand, in response to a determination, at 406, that a chassis belonging to the pool to which the customer belongs is not available, a determination is made, at block 408, as to whether a chassis belonging to a pool to which the customer does not belong (e.g., a non-customer pool) is available. For example, a chassis belonging to a chassis pool to which the customer does not belong may be currently available. In this case, at block 410, chassis optimization system 121 may determine to recommend a mismount of the chassis. A mismounts may include when a chassis belong to a pool is used to receive a container belonging to a customer that does not belong to the pool. This mismatch is not always desirable, but it may allow optimization of the unit throughput by enabling a chassis to be used that otherwise might sit unused. In embodiments, chassis optimization system 121 may generate mismount recommendations only when it is determined that the mismounted chassis may not be needed to support a pool container (e.g., a container belonging to a customer that belongs to the pool to which the mismounted belongs) before the end of the planning horizon, and/or when the mismounted chassis is able to be flipped back (e.g., the mismounted container is removed from the chassis) once a chassis belonging to a pool to which the customer belongs becomes available. In this case, in response to the determination to mismount the pool chassis, the container may be loaded onto the chassis belonging to the chassis pool to which the customer does not belong at block 412. At block 414, the container mounted on the chassis belonging to the chassis pool to which the customer does not belong may be placed on a parking space of a parking lot of the hub and may wait, at block 416, until a chassis belonging to a chassis pool to which the customer belongs becomes available (e.g., from a deramping event, from a replenishment event, etc.). Once a chassis belonging to a chassis pool to which the customer belongs becomes available, operations flow to block 420.

On the other hand, in response to a determination, at block 408, that a chassis belonging to a pool to which the customer does not belong is not available either, chassis optimization system 121 may determine to recommend that the container be stored in a stacked parking lot, where the container may wait, at block 416, until a chassis belonging to a chassis pool to which the customer belongs or a chassis belonging to a pool to which the customer does not belong becomes available (e.g., from a deramping event, from a replenishment event, etc.). Once a chassis belonging to a chassis pool to which the customer belongs or a chassis belonging to a pool to which the customer does not belong becomes available, operations flow to block 420.

At block 436, a notification may be sent to a customer that the container is ready for pickup by the customer, and at block 438 the system waits for the customer to pickup the container. At block 440, the customer may pickup the container along with the chassis on which the container is mounted and may leave the hub ending the process at block 442.

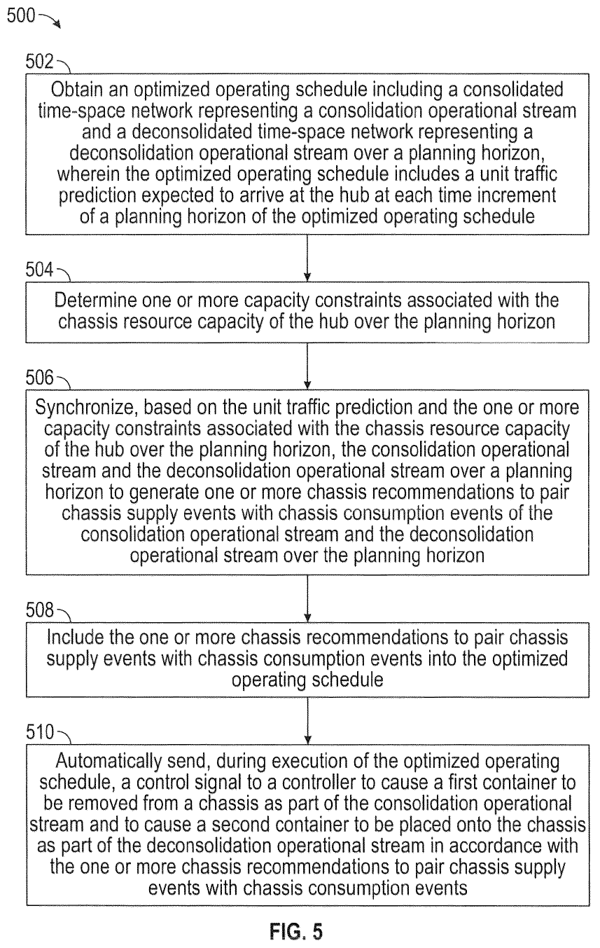

FIG. 5 shows a high-level flow diagram 500 of operation of a system configured for providing functionality for optimizing utilization of chassis resources of a hub in accordance with embodiments of the present disclosure. For example, the functions illustrated in the example blocks shown in FIG. 5 may be performed by system 100 of FIG. 1 according to embodiments herein. In embodiments, the operations of the method 500 may be stored as instructions that, when executed by one or more processors, cause the one or more processors to perform the operations of the method 500.

At block 502, an optimized operating schedule including a consolidated time-space network representing a consolidation operational stream and a deconsolidated time-space network representing a deconsolidation operational stream over a planning horizon is obtained. In embodiments, the optimized operating schedule includes a unit traffic prediction expected to arrive at the hub at each time increment of a planning horizon of the optimized operating schedule. In embodiments, functionality of a resource optimization system (e.g., resource optimization system 129 as illustrated in FIG. 2) may be used to obtain an optimized operating schedule including a consolidated time-space network representing a consolidation operational stream and a deconsolidated time-space network representing a deconsolidation operational stream over a planning horizon. In embodiments, the resource optimization system may perform operations to obtain an optimized operating schedule including a consolidated time-space network representing a consolidation operational stream and a deconsolidated time-space network representing a deconsolidation operational stream over a planning horizon according to operations and functionality as described above with reference to resource optimization system 129 and as illustrated in FIGS. 1-4.

At block 504, one or more capacity constraints associated with the chassis resource capacity of the hub over the planning horizon are determined. In embodiments, functionality of a capacity constraints manager (e.g., capacity constraints manager 322 as illustrated in FIG. 3) may be used to determine one or more capacity constraints associated with the chassis resource capacity of the hub over the planning horizon. In embodiments, the capacity constraints manager may perform operations to determine one or more capacity constraints associated with the chassis resource capacity of the hub over the planning horizon according to operations and functionality as described above with reference to capacity constraints manager 322 and as illustrated in FIGS. 1-4.

At block 506, the consolidation operational stream and the deconsolidation operational stream over a planning horizon are synchronized based on the unit traffic prediction and the one or more capacity constraints associated with the chassis resource capacity of the hub over the planning horizon to generate one or more chassis recommendations to pair chassis supply events with chassis consumption events of the consolidation operational stream and the deconsolidation operational stream over the planning horizon. In embodiments, functionality of a chassis optimization system (e.g., chassis optimization system 121 as illustrated in FIGS. 2 and 3) may be used to synchronize, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon. In embodiments, the chassis optimization system may perform operations to synchronize, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon according to operations and functionality as described above with reference to chassis optimization system 121 and as illustrated in FIGS. 1-4.

At block 508, the one or more chassis recommendations to pair chassis supply events with chassis consumption events is included into the optimized operating schedule. In embodiments, functionality of a chassis optimizer (e.g., chassis optimizer 323 as illustrated in FIG. 3) may be used to include the one or more chassis recommendations to pair chassis supply events with chassis demand events into the optimized operating schedule. In embodiments, the chassis optimizer may perform operations to include the one or more chassis recommendations to pair chassis supply events with chassis demand events into the optimized operating schedule according to operations and functionality as described above with reference to chassis optimizer 323 and as illustrated in FIGS. 1-4.

At block 510, a control signal is automatically to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events during executing of the optimized operating schedule. In embodiments, functionality of a operations server (e.g., operations server 125 as illustrated in FIGS. 1-3) may be used to automatically send, during executing of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events. In embodiments, the operations server may perform operations to automatically send, during executing of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events according to operations and functionality as described above with reference to operations server 125 and as illustrated in FIGS. 1-4.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-5 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of optimizing utilization of chassis resources associated with a hub, comprising:
obtaining an optimized operating schedule including a consolidated time-space network representing a consolidation operational stream and a deconsolidated time-space network representing a deconsolidation operational stream over a planning horizon, wherein the optimized operating schedule includes a unit traffic prediction expected to arrive at the hub at each time increment of a planning horizon of the optimized operating schedule;
determining one or more capacity constraints associated with the chassis resource capacity of the hub over the planning horizon;
synchronizing, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon;
including the one or more chassis recommendations to pair chassis supply events with chassis consumption events into the optimized operating schedule; and
automatically sending, during execution of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events.

2. The method of claim 1, wherein the unit traffic prediction includes a prediction of containers and chassis expected to arrive at the hub at each stage of the consolidation operational stream and a prediction of containers expected to arrive at the hub at each stage of the deconsolidation operational stream at time increment of the planning horizon of the optimized operating schedule.

3. The method of claim 1, wherein synchronizing the consolidation operational stream and the deconsolidation operational stream over the planning horizon includes synchronizing ramping operations of the consolidation operational stream and deramping operations of the deconsolidation operational stream to generate the one or more chassis recommendations to pair chassis supply events with chassis consumption events.

4. The method of claim 3, wherein the one or more recommendations to pair chassis supply events with chassis consumption events include one or more recommendations to perform a ramping operations to release a chassis from a first container, and to perform a corresponding deramping operations to place a second container on the chassis.

5. The method of claim 1, wherein the one or more capacity constraints associated with the chassis resource capacity of the hub include one or more of:
availability of chassis of the chassis resource capacity;
a type of the chassis of the chassis resource capacity;
a size of the chassis of the chassis resource capacity; and
chassis pool characteristics of the chassis of the chassis resource capacity.

6. The method of claim 5, further comprising:
determining that a chassis belonging to a first chassis pool to which a first customer belongs is not available to receive a container belonging to the first customer.

7. The method of claim 6, wherein synchronizing, based on the unit traffic prediction and the one or more capacity constraints associated with the chassis resource capacity of the hub over the planning horizon, the consolidation operational stream and the deconsolidation operational stream over a planning horizon includes:
recommending a mismount of the container belonging to the first customer to a chassis belonging to a second chassis pool to which the first customer does not belong.

8. The method of claim 7, wherein recommending the mismount is in response to one or more of:
a determination that the chassis belonging to the second chassis pool to which the first customer does not belong is not needed to receive a container belonging to a second customer that belongs to the second chassis pool before the end of the planning horizon;
a determination that the container belonging to the first customer is to be removed from the chassis belonging to the second chassis pool to which the first customer does not belong when the chassis belonging to the first chassis pool to which the first customer belongs becomes available.

9. The method of claim 6, wherein synchronizing, based on the unit traffic prediction and the one or more capacity constraints associated with the chassis resource capacity of the hub over the planning horizon, the consolidation operational stream and the deconsolidation operational stream over a planning horizon includes:
recommending placing the container belonging to the first customer in a stacking parking lot until the chassis belonging to the first chassis pool to which the first customer belongs becomes available.

10. A system configured to optimize utilization of chassis resources in a train yard, comprising:
at least one processor; and
a memory operably coupled to the at least one processor and storing processor-readable code that, when executed by the at least one processor, is configured to perform operations including:
obtaining an optimized operating schedule including a consolidated time-space network representing a consolidation operational stream and a deconsolidated time-space network representing a deconsolidation operational stream over a planning horizon, wherein the optimized operating schedule includes a unit traffic prediction expected to arrive at the hub at each time increment of a planning horizon of the optimized operating schedule;
determining one or more capacity constraints associated with the chassis resource capacity of the hub over the planning horizon;
synchronizing, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon;
including the one or more chassis recommendations to pair chassis supply events with chassis consumption events into the optimized operating schedule; and
automatically sending, during execution of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events.

11. The system of claim 10, wherein the unit traffic prediction includes a prediction of containers and chassis expected to arrive at the hub at each stage of the consolidation operational stream and a prediction of containers expected to arrive at the hub at each stage of the deconsolidation operational stream at time increment of the planning horizon of the optimized operating schedule.

12. The system of claim 10, wherein synchronizing the consolidation operational stream and the deconsolidation operational stream over the planning horizon includes synchronizing ramping operations of the consolidation operational stream and deramping operations of the deconsolidation operational stream to generate the one or more chassis recommendations to pair chassis supply events with chassis consumption events.

13. The system of claim 12, wherein the one or more recommendations to pair chassis supply events with chassis consumption events include one or more recommendations to perform a ramping operations to release a chassis from a first container, and to perform a corresponding deramping operations to place a second container on the chassis.

14. The system of claim 10, wherein the one or more capacity constraints associated with the chassis resource capacity of the hub include one or more of:
availability of chassis of the chassis resource capacity;
a type of the chassis of the chassis resource capacity;
a size of the chassis of the chassis resource capacity; and
chassis pool characteristics of the chassis of the chassis resource capacity.

15. The system of claim 14, wherein the operations further comprise:
determining that a chassis belonging to a first chassis pool to which a first customer belongs is not available to receive a container belonging to the first customer.

16. The system of claim 15, wherein synchronizing, based on the unit traffic prediction and the one or more capacity constraints associated with the chassis resource capacity of the hub over the planning horizon, the consolidation operational stream and the deconsolidation operational stream over a planning horizon includes:
recommending a mismount of the container belonging to the first customer to a chassis belonging to a second chassis pool to which the first customer does not belong.

17. The system of claim 16, wherein recommending the mismount is in response to one or more of:
a determination that the chassis belonging to the second chassis pool to which the first customer does not belong is not needed to receive a container belonging to a second customer that belongs to the second chassis pool before the end of the planning horizon;
a determination that the container belonging to the first customer is to be removed from the chassis belonging to the second chassis pool to which the first customer does not belong when the chassis belonging to the first chassis pool to which the first customer belongs becomes available.

18. The method of claim 14, wherein synchronizing, based on the unit traffic prediction and the one or more capacity constraints associated with the chassis resource capacity of the hub over the planning horizon, the consolidation operational stream and the deconsolidation operational stream over a planning horizon includes:
recommending placing the container belonging to the first customer in a stacking parking lot until the chassis belonging to the first chassis pool to which the first customer belongs becomes available.

19. A computer-based tool for optimizing utilization of chassis resources in a train yard, the computer-based tool including non-transitory computer readable media having stored thereon computer code which, when executed by a processor, causes a computing device to perform operations comprising:
obtaining an optimized operating schedule including a consolidated time-space network representing a consolidation operational stream and a deconsolidated time-space network representing a deconsolidation operational stream over a planning horizon, wherein the optimized operating schedule includes a unit traffic prediction expected to arrive at the hub at each time increment of a planning horizon of the optimized operating schedule;
determining one or more capacity constraints associated with the chassis resource capacity of the hub over the planning horizon;
synchronizing, based on the unit traffic prediction and the one or more capacity constraints associated with the chassis resource capacity of the hub over the planning horizon, the consolidation operational stream and the deconsolidation operational stream over a planning horizon to generate one or more chassis recommendations to pair chassis supply events with chassis consumption events of the consolidation operational stream and the deconsolidation operational stream over the planning horizon;
including the one or more chassis recommendations to pair chassis supply events with chassis consumption events into the optimized operating schedule; and
automatically sending, during execution of the optimized operating schedule, a control signal to a controller to cause a first container to be removed from a chassis as part of the consolidation operational stream and to cause a second container to be placed onto the chassis as part of the deconsolidation operational stream in accordance with the one or more chassis recommendations to pair chassis supply events with chassis consumption events.

20. The computer-based tool of claim 19, wherein synchronizing, based on the unit traffic prediction and the one or more capacity constraints associated with the chassis resource capacity of the hub over the planning horizon, the consolidation operational stream and the deconsolidation operational stream over a planning horizon includes:
determining that a chassis belonging to a first chassis pool to which a first customer belongs is not available to receive a container belonging to the first customer; and
recommending a mismount of the container belonging to the first customer to a chassis belonging to a second chassis pool to which the first customer does not belong.
